(19) United States
(12) Patent Application Publication
(10) Pub. No.: US 2014/0139124 A1
(43) Pub. Date: May 22, 2014

(54) ORGANIC LIGHT EMITTING DISPLAY

(71) Applicant: SAMSUNG DISPLAY CO., LTD., Yongin-City (KR)

(72) Inventors: Chang-Yeop Kim, Yongin-City (KR); Seung-Kyu Lee, Yongin-City (KR)

(73) Assignee: Samsung Display Co., Ltd., Youngin-City (KR)

(21) Appl. No.: 13/795,201

(22) Filed: Mar. 12, 2013

(30) Foreign Application Priority Data
Nov. 22, 2012 (KR) 10-2012-0133025

(51) Int. Cl. H05B 37/00

(52) U.S. Cl. CPC H05B 37/00
USPC 315/172

(57) ABSTRACT

There is provided an organic light emitting display capable of displaying an image with uniform brightness while securing a high aperture ratio. The organic light emitting display includes a plurality of first subpixels and a plurality of second subpixels alternately arranged in a single column line and a third subpixel arranged in another column line adjacent to the first subpixels and the second subpixels. First subpixels positioned in the single column line may be alternately electrically coupled to different data lines.

### CLAIM OF PRIORITY

This application makes reference to, incorporates the same herein, and claims all benefits accruing under 35 U.S.C. §119 from an application for ORGANIC LIGHT EMITTING DISPLAY earlier filed in the Korean Intellectual Property Office on 22 Nov. 2012 and there duly assigned Serial No. 10-2012-0133025.

### BACKGROUND THE INVENTION

1. Field of the Invention

The present invention relates to an organic light emitting display, and more particularly, to an organic light emitting display capable of displaying an image with uniform brightness while securing a high aperture ratio.

2. Description of the Related Art

An organic light emitting display for displaying an image using an organic light emitting diode (OLED) that is a self-emissive element has high brightness and color purity and may be spotlighted as a next generation display device.

In the organic light emitting display, a plurality of pixels consist of red subpixels, green subpixels and blue subpixels and may display various color images.

The red subpixels, the green subpixels, and the blue subpixels may be arranged in various shapes and are commonly arranged in stripes where subpixels of the same color are arranged in units of columns.

However, when the subpixels are arranged in stripes, an aperture ratio may be reduced by black matrices positioned among the subpixels so that the quality of a high resolution display is deteriorated.

### SUMMARY OF THE INVENTION

Accordingly, the present invention has been made to provide an organic light emitting display capable of displaying an image with uniform brightness while securing a high aperture ratio.

In order to achieve the foregoing and other aspects of the present invention, there may be provided an organic light emitting display, including a plurality of first subpixels and a plurality of second subpixels alternately arranged in a single column line and a third subpixel arranged in another column line adjacent to the first subpixels and the second subpixels. First subpixels positioned in the single column line may be alternately electrically coupled to different data lines.

Each of the first subpixels may include a first switching transistor and a first pixel circuit. A first switching transistor positioned in an ith (i is an odd number or an even number) row line may be coupled to a kth (k is a natural number) data line. A first switching transistor positioned in an (i+1)th row line may be coupled to a (k+1)th data line. Second subpixels positioned in the same column line may be alternately electrically coupled to different data lines. Each of the second subpixels may include a second switching transistor and a second pixel circuit. A second switching transistor positioned in an ith (i is an odd number or an even row line may be coupled to a (k+1)th (k is a natural number) data line. A second switching transistor positioned in an (i+1)th row line may be coupled to a kth data line.

Third subpixels positioned in a given column line may all be electrically coupled to the same data line. The organic light emitting display may further include a scan driver for sequentially supplying scan signals to scan lines and a data driver for supplying data signals to data lines. The data driver may alternately supply a red data signal and a green data signal to the data lines electrically coupled to the first subpixel and the second subpixel and may sequentially supply a blue data signal to the data lines coupled to the third subpixel.

The organic light emitting display may further include demultiplexers coupled to output lines of the data driver to transmit the data signals supplied from the output lines to a plurality of data lines. The data driver may sequentially supply the red, green, and blue data signals to the output lines. Each of the demultiplexers may include a plurality of transistors for transmitting the data signals supplied from the output lines to the plurality of data lines; these signals may be in synchronization with control signals. An order in which the control signals may be supplied to the transistors electrically coupled to the first subpixels and the second subpixels may be changed every horizontal period. The control signal may be supplied to the transistors electrically coupled to the third subpixels for each horizontal period after the control signals are supplied to transistors electrically coupled to the first subpixels and the second subpixels.

The first subpixel may be a red subpixel. The second subpixel may be a green subpixel. The third subpixel may be a blue subpixel. The first subpixel and the second subpixel may be arranged to be positioned on an upper side and a lower side in one row line. The third subpixel may be arranged in a column designated sequentially higher than the designation of the column holding the first subpixel and the second subpixel.

In the organic light emitting display according to the present invention, the first subpixel and the second subpixel may be arranged on the upper side and the lower side of the same row line, and the third subpixel may be arranged in the column line adjacent to the first subpixel and the second subpixel. When the pixels are arranged as described above, high resolution may be realized and a high aperture ratio may be secured.

In addition, according to the present invention, the first subpixels positioned in the same column line may be alternately electrically coupled to different data lines. The second subpixels positioned in the same column line in which the first subpixels are positioned may be alternately electrically coupled to different data lines. In this case, a specific data line may be alternately coupled to the first subpixels and the second subpixels so that an image with uniform brightness may be displayed without a specific color being emphasized.

### BRIEF DESCRIPTION OF THE DRAWINGS

A more complete appreciation of the invention and many of the attendant advantages thereof will be readily apparent as the same becomes better understood by reference to the following detailed description when considered in conjunction with the accompanying drawings, in which like reference symbols indicate the same or similar components, wherein:

FIG. 1 is a plan view illustrating a pixel arrangement structure of an organic light emitting display according to an embodiment of the present invention;

FIG. 2 is a view illustrating the organic light emitting display according to an embodiment of the present invention;

FIG. 3 is a view illustrating a method of supplying data signals according to an embodiment of the present invention;

FIG. 4 is a view illustrating an organic light emitting display according to another embodiment of the present invention;

FIG. 5 is a view illustrating an embodiment of the demultiplexer illustrated in FIG. 4; and

FIG. 6 is a view illustrating a method of supplying data signals according to another embodiment of the present invention.

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

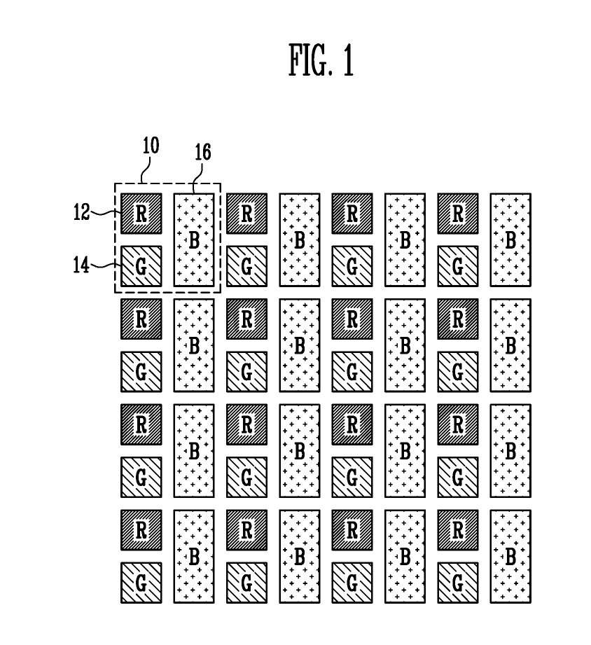

Hereinafter, an organic light emitting display will be described in detail as follows with reference to FIGS. 1 to 6. Preferred embodiments by which those skilled in the art may easily perform the present invention are included.

FIG. 1 is a plan view illustrating a pixel arrangement structure of an organic light emitting display according to an embodiment of the present invention.

Referring to FIG. 1, in the organic light emitting display according to an embodiment of the present invention, first subpixels 12, second subpixels 14, and third subpixels 16 are arranged to form pixels 10, each pixel 10 comprising a first subpixel 12, a second subpixel 14 and a third subpixel 16.

Here, the first subpixels 12 and the second subpixels 14 are alternately arranged in a single column line, and the third subpixels 16 are arranged in another column line adjacent to the column line in which the first subpixels 12 and the second subpixels 14 are arranged. For this purpose, the first subpixels 12 and the second subpixels 14 are arranged in the upper side and the lower side of each row line, respectively, and the third subpixels 16 are each arranged in one row line. In this case, the third subpixels 16 are formed to be in a column designated sequentially higher than the designation of the column holding the first subpixels 12 and the second subpixels 14.

According to the present invention, when the subpixels 12, 14, and 16 are arranged, the subpixels 12, 14, and 16 may realize high resolution by a subpixel rendering technique. In addition, when the subpixels 12, 14, and 16 are arranged according to the present invention, the area of black matrices may be reduced in comparison with the conventional art in which the subpixels are arranged in stripes so that it is possible to secure a high aperture ratio.

According to an embodiment of the present invention, the first subpixels 12 may be set as red subpixels R, the second subpixels 14 may be set as green subpixels G, and the third subpixels 16 may be set as blue subpixels B. In general, in the OLED, the blue subpixels B may have the shortest life. Therefore, according to an embodiment of the present invention, the third subpixels 16, having the largest area of the three subpixels, may be set as the blue subpixels B in order to improve the lifetime of the OLED.

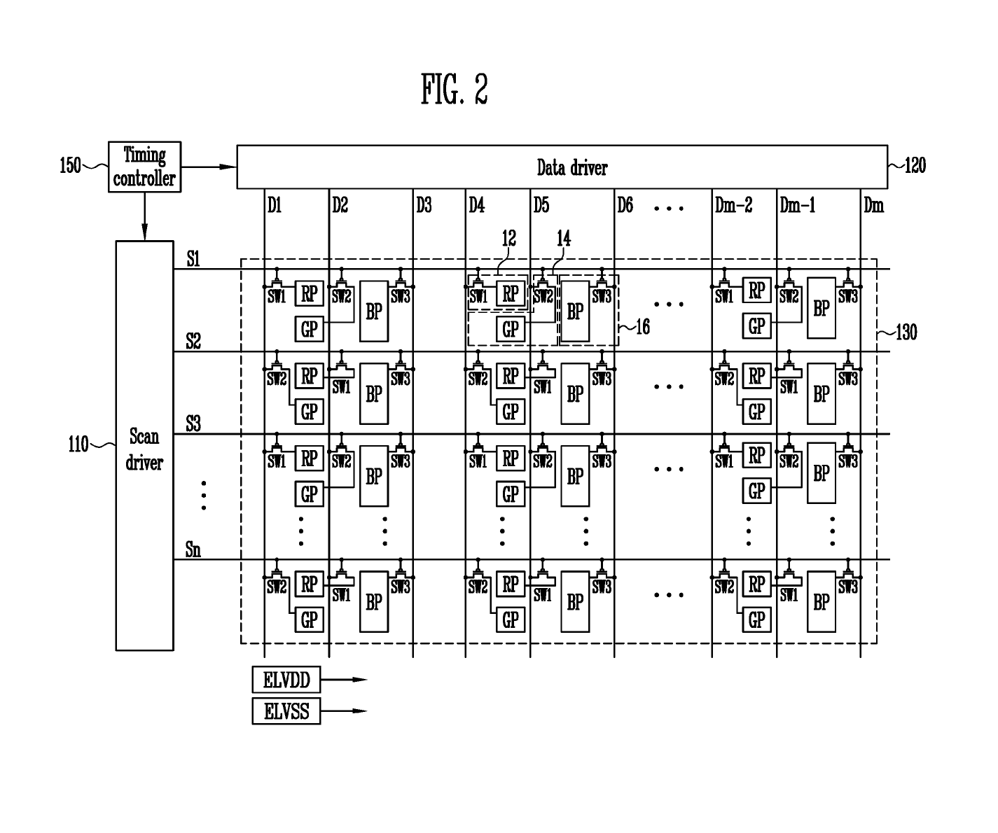

FIG. 2 is a view illustrating the organic light emitting display according to an embodiment of the present invention.

Referring to FIG. 2, an organic light emitting display according to an embodiment of the present invention may include a pixel unit 130 including subpixels 12, 14, and 16 positioned to be coupled to scan lines S1 to Sn and data lines D1 to Dm, a scan driver 110 for driving the scan lines S1 to Sn, a data driver 120 for driving the data lines D1 to Dm, and a timing controller 150 for controlling the scan driver 110 and the data driver 120.

The first subpixels 12 and the second subpixels 14 may be formed in the upper side and the lower side of one row line, respectively, and may be alternately and repeatedly arranged in the same column. The third subpixels 16 may be formed in one row line and may be arranged in a column adjacent to the column holding the first subpixels 12 and the second subpixels 14. Here, the subpixels 12, 14, and 16 positioned in the same row line may be driven by a scan line S positioned in the same row line.

The first subpixel 12, the second subpixel 14, and the third subpixel 16 may include switching transistors SW1, SW2, and SW3 and pixel circuits RP, GP, and BP, respectively.

The first subpixel 12 may include the first switching transistor SW1 and the pixel circuit RP. The pixel circuit RP may include a driving transistor and an organic light emitting diode (OLED) (not shown). The pixel circuit RP may generate red light with predetermined brightness to correspond to the data signal supplied via the first switching transistor SW1. According to an embodiment of the present invention, the pixel circuit RP may be selected from various publicly known circuits.

The gate electrode of the first switching transistor SW1 may be coupled to the scan line S, and the source electrode of the first switching transistor SW1 may be coupled to a data line D. The drain electrode of the first switching transistor SW1 may be coupled to the pixel circuit RP. The first switching transistor SW1 may be turned on when a scan signal is supplied to transmit the data signal from the data line to the pixel circuit RP.

Alternatively, according to another embodiment of the present invention, the first switching transistors SW1 positioned in the same column line may be alternately and electrically coupled to different data lines. That is, the first switching transistors SW1 formed in an ith (i is an odd number or an even number) row line may be coupled to a kth (k is a natural number) data line Dk. The first switching transistors SW1 formed in an (i+1)th row line may be coupled to a (k+1)th data line Dk+1.

The second subpixel 14 may include the second switching transistor SW2 and the pixel circuit GP. The pixel circuit GP may include a driving transistor and an OLED (not shown). The pixel circuit GP may generate green light with predetermined brightness to correspond to the data signal supplied via the second switching transistor SW2. According to an embodiment of the present invention, the pixel circuit GP may be selected from various publicly [symbol] circuits. The gate electrode of the second switching transistor SW2 may be coupled to the scan line S, and the source electrode of the first switching transistor SW1 may be coupled to the data line D. The drain electrode of the second switching transistor SW2 may be coupled to the pixel circuit GP. The second switching transistor SW2 may be turned on when a scan signal is supplied to transmit the data signal from the data line to the pixel circuit GP.

Alternatively, according to an embodiment of the present invention, the second switching transistors SW2 positioned in the same column line may be alternately and electrically coupled to different data lines. That is, the second switching transistors SW2 formed in the ith row line may be coupled to the (k+1)th data line D(k+1). The second switching transistors SW2 formed in the (i+1)th row line may be coupled to the kth data line Dk.

As described above, when the switching transistors SW1 and SW2 of the first subpixels 12 and the second subpixels 14 positioned in the same column are alternately arranged, red and green data signals may be alternately supplied to the kth data line Dk and the (k+1)th data line Dk+1 so that an image with uniform brightness may be displayed.

Describing the above in detail, the data driver 120 may supply data signals using channels coupled to the data lines D1 to Dm. Here, the channels of the data driver 120 may have a predetermined deviation (for example, the deviation of a digital analog converter). Therefore, although the same data signal is supplied, data signals of different voltages may be supplied to the channels, respectively.

Here, when a deviation between adjacent channels is set to be large, a predetermined color may be emphasized. For example, when only the red data signal is supplied to the kth data line Dk and only the green data signal is supplied to the (k+1)th data line D(k+1), red or green brightness is emphasized in the respective columns so that a non-uniform image may be displayed. However, according to an embodiment of the present invention, when the red and green data signals are alternately supplied to the kth and (k+1)th data lines Dk and D(k+1), an image with uniform brightness corresponding to the average brightness of the red and green subpixels may be displayed.

In addition, due to a process deviation, the data lines D1 to Dm may have different resistance values. Therefore, according to an embodiment of the present invention, when the red and green data signals are alternately supplied to the kth and (k+1)th data lines Dk and D(k+1), the different resistance values may be averaged so that an image with uniform brightness may be displayed.

The third subpixel 16 may include the third switching transistor SW3 and the pixel circuit BP. The pixel circuit BP may include a driving transistor and an OLED (not The pixel circuit BP may generate green light with predetermined brightness to correspond to the data signal supplied via the third switching transistor SW3. Alternatively, according to an embodiment of the present invention, the pixel circuit BP may be selected from various publicly known circuits.

The gate electrode of the third switching transistor SW3 may be coupled to the scan line S, and the source electrode of the third switching transistor SW3 may be coupled to a data line D. The drain electrode of the third switching transistor SW3 may be coupled to the pixel circuit GP. The third switching transistor SW3 may be turned on when a scan signal is supplied to transmit the data signal from the data line to the pixel circuit BP. The third switching transistors SW3 positioned in the same column line may be coupled to the same data line D. In that case, the third subpixels 16 positioned in the same column line all respond to the data signal from the same data line D.

The scan driver 110 may sequentially supply scan signals to the scan lines S1 to Sn. When the scan signals are sequentially supplied to the scan lines S1 to Sn, the subpixels 12, 14, and 16 may be sequentially selected in units of row lines.

The data driver 120 may sequentially supply data signals to the data lines D1 to Dm in synchronization with the scan signals. The data signals supplied to the data lines D1 to Dm may be supplied to the subpixels 12, 14, and 16 selected by the scan signals.

The pixel unit 130 may include the subpixels 12, 14, and 16. The subpixels 12, 14, and 16 may receive the first power supply ELVDD and the second power supply ELVSS. Each of the subpixels 12, 14, and 16 may control the amount of current supplied from the first power supply ELVDD to the second power supply ELVSS via the OLED (not shown), which corresponds to the data signal to generate light with predetermined brightness.

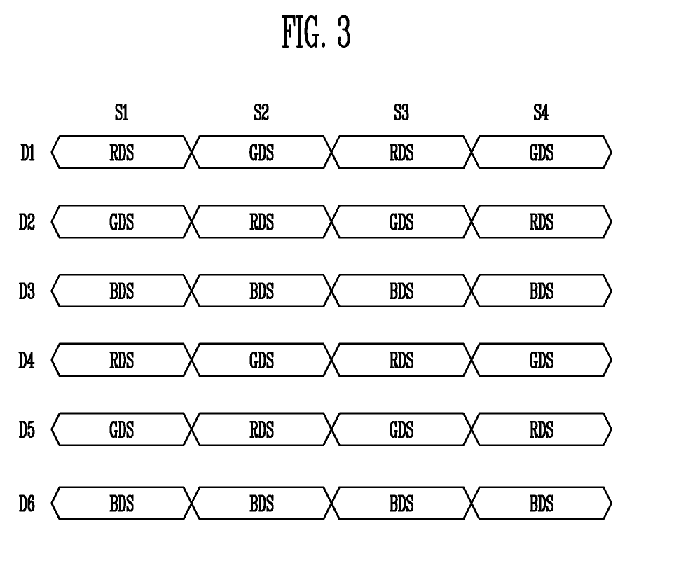

FIG. 3 is a view illustrating a method of supplying data signals according to an embodiment of the present invention.

Referring to FIG. 3, according to an embodiment of the present invention, only a blue data signal BDS is supplied to data lines D3 and D6, which are coupled to the blue subpixels 16. A red data signal RDS and a green data signal GDS are alternately supplied to data lines D1, D2, D4, and D5, which are alternately coupled to the red subpixels 12 and the green subpixels 14. When the red data signal RDS and the green data signal GDS are alternately supplied in this manner, an image with uniform brightness may be displayed.

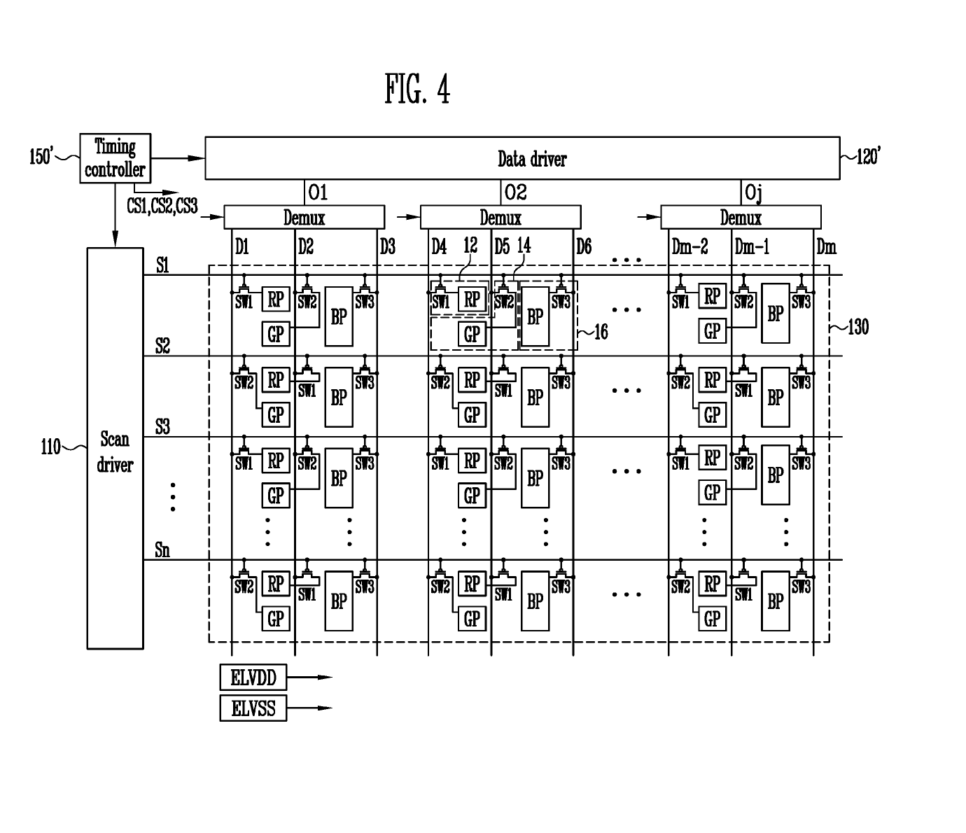

FIG. 4 is a view illustrating an organic light emitting display according to another embodiment of the present invention. In FIG. 4, like reference numerals refer to like elements throughout, and detailed description thereof will be omitted.

Referring to FIG. 4, the organic light emitting display according to another embodiment of the present invention includes a pixel unit 130 including subpixels 12, 14, and 16 positioned to be coupled to scan lines S1 to Sn and data lines D1 to Dm, a scan driver 110 for driving the scan lines S1 to Sn, a data driver 120′ for driving the data lines D1 to Dm, demultiplexers 140 coupled to the output lines O1 to Oj of the data driver 120′, and a timing controller 150′ for controlling the scan driver 110, the data driver 120′, and the demultiplexers 140.

The organic light emitting display according to another embodiment of the present invention may further include the demultiplexers 140 coupled to the channels, that is, the output lines O1 to Oj of the data driver 120′. Each of the demultiplexers 140 may be coupled to a plurality of data lines, for example, three data lines. The demultiplexer 140 may supply the data signal supplied by one output line to the three data lines so that the number of channels of the data driver 120′ may be minimized.

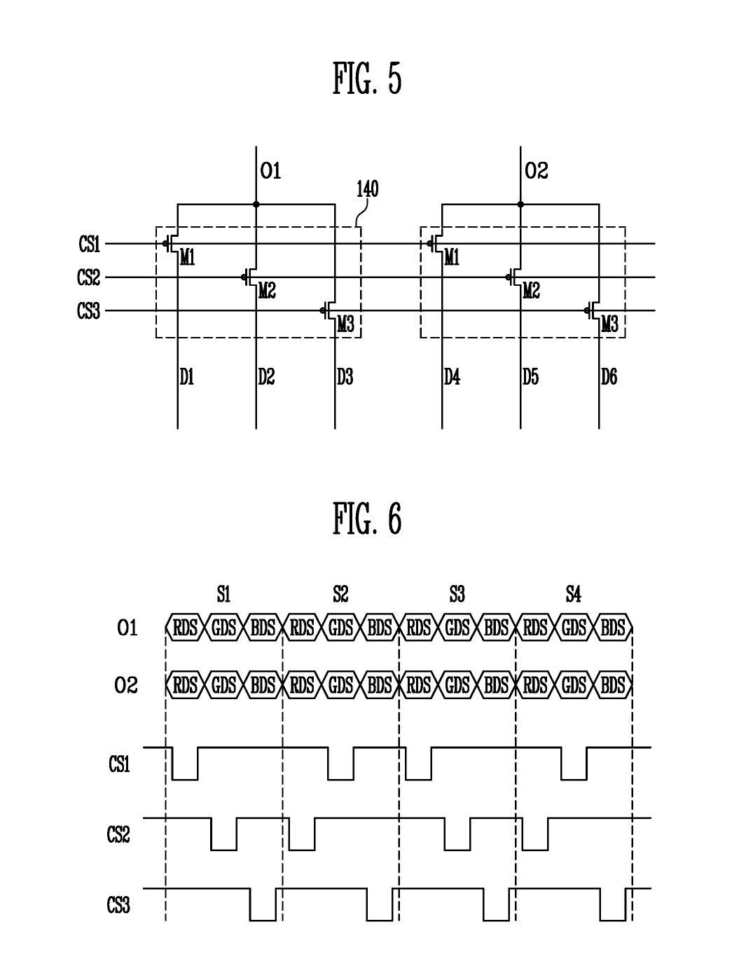

FIG. 5 is a view illustrating an embodiment of the demultiplexer illustrated in FIG. 4. In FIG. 5, for convenience sake, each of the demultiplexers 140 is coupled to three data lines. However, the present invention is not limited to the above.

Referring to FIG. 5, each of the demultiplexers 140 according to an embodiment of the present invention includes a first transistor M1 to a third transistor M3.

The first transistor M1 may be turned on when a first control signal CS1 is supplied from the timing controller 150′ to transmit the data signals supplied to the output lines O1 and O2 to the data lines D1 and D4.

The second transistor M2 may be turned on when a second control signal CS2 is supplied from the timing controller 150′ to transmit the data signals supplied to the output lines O1 and O2 to the data lines D2 and D5.

The third transistor M3 may be turned on when a third control signal CS3 is supplied from the timing controller 150′ to transmit the data signals supplied to the output lines O1 and O2 to the data lines D3 and D6.

FIG. 6 is a view illustrating a method of supplying data signals according to another embodiment of the present invention.

Referring to FIG. 6, the data driver 120′ may sequentially supply the red data signal RDS, the green data signal GDS, and the blue data signal BDS to the output lines O1, 02, . . . every horizontal period.

In this embodiment of the invention, the order in which the first control signal CS1 and the second control signal CS2 are supplied to the transistors M1 and M2, which are coupled to the data lines D1, D2, D4, D5, . . . , which are coupled to the first subpixel 12 and the second subpixel 14, may be changed every horizontal period. For example, when the first control signal CS1 and the second control signal CS2 are supplied in a current horizontal period in the order of the first control signal CS1 and the second control signal CS2, the first control signal CS1 and the second control signal CS2 are supplied in a next horizontal period in the order of the second control signal CS2 and the first control signal CS1. On the other hand, the third control signal CS3 is supplied to the transistor M3, which is coupled to the data lines D3 and D6, which are coupled to the third subpixel 16, in the same order every horizontal period. For example, in each horizontal period, the third control signal CS3 may be supplied after the first control signal CS1 and the second control signal CS2 are supplied.

Describing operation processes, first, the control signals may be supplied in a specific horizontal period in the order of the first control signal CS1, the second control signal CS2, and the third control signal CS3. When the first control signal CS1 is supplied, the first transistor M1 may be turned on so that the red data signal RDS is supplied to the data lines D1 and D4. Then, the red data signal RDS may be supplied to the first subpixel 12 positioned in the ith row line.

When the second control signal CS2 is supplied, the second transistor M2 may be turned on so that the red data signal GDS is supplied to the data lines D2 and D5. Then, the green data signal GDS may be supplied to the second subpixel 14 positioned in the ith row line.

When the third control signal CS3 is supplied, the third transistor M3 may be turned on so that the blue data signal BDS is supplied to the data lines D3 and D6. Then, the blue data signal BDS may be supplied to the third subpixel 16 positioned in the ith row line.

Then, in the next horizontal period, the control signals may be supplied in the order of the second control signal CS2, the first control signal CS1, and the third control signal CS3. When the second control signal CS2 is supplied, the second transistor M2 may be turned on so that the red data signal RDS is supplied to the data lines D2 and D5. Then, the red data signal RDS may be supplied to the first subpixel 12 positioned in the (i+1)th row line.

When the first control signal CS1 is supplied, the first transistor ml may be turned on so that the green data signal GDS is supplied to the data lines D1 and D4. Then, the green data signal GDS may be supplied to the second subpixel 14 positioned in the (i+1)th row line.

When the third control signal CS3 is supplied, the third transistor M3 may be turned on so that the blue data signal BDS is supplied to the data lines D3 and D6. Then, the blue data signal BDS may be supplied to the third subpixel 16 positioned in the (i+1)th row line.

According to an embodiment of the present invention, desired data signals may be supplied to the subpixels 12, 14, and 16 while repeating the above-described processes. According to another embodiment of the present invention, the red and green data signals are alternately supplied to the kth and (k+1)th data lines Dk and D(k+1) so that an image with uniform brightness may be displayed.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display, comprising:
a plurality of first subpixels and a plurality of second subpixels alternately arranged in a single column line; and
a third subpixel arranged in another column line adjacent to the first subpixels and the second subpixels,
the first subpixels positioned in the single column line being alternately electrically coupled to different data lines.

2. The organic light emitting display as claimed in claim 1,
each of the first subpixels comprising a first switching transistor and a first pixel circuit,
a first switching transistor positioned in an ith (i is an odd number or an even number) row line being coupled to a kth (k is a natural number) data line, and
a first switching transistor positioned in an (i+1)th row line being coupled to a (k+1)th data line.

3. The organic light emitting display as claimed in claim 1, second subpixels positioned in the single column line being alternately electrically coupled to different data lines.

4. The organic light emitting display as claimed in claim 2,
each of the second subpixels comprising a second switching transistor and a second pixel circuit,
a second switching transistor positioned in an ith (i is an odd number or an even number) row line being coupled to a (k+1)th (k is a natural number) data line, and
a second switching transistor positioned in an (i+1)th row line being coupled to a kth data line.

5. The organic light emitting display as claimed in claim 3, third subpixels positioned in the same column line being electrically coupled to the same data line.

6. The organic light emitting display as claimed in claim 5, further comprising:
a scan driver for sequentially supplying scan signals to scan lines; and
a data driver for supplying data signals to data lines.

7. The organic light emitting display as claimed in claim 6, the data driver alternately supplying a red data signal and a green data signal to the data lines electrically coupled to the first subpixel and the second subpixel and sequentially supplying a blue data signal to the data lines coupled to the third subpixel.

8. The organic light emitting display as claimed in claim 6, further comprising demultiplexers coupled to output lines of the data driver to transmit the data signals supplied from the output lines to a plurality of data lines.

9. The organic light emitting display as claimed in claim 8, the data driver sequentially supplying the red, green, and blue data signals to the output lines.

10. The organic light emitting display as claimed in claim 9, each of the demultiplexers comprising a plurality of transistors for transmitting the data signals supplied from the output lines to the plurality of data lines in synchronization with control signals.

11. The organic light emitting display as claimed in claim 10, an order in which the control signals are supplied to transistors electrically coupled to the first subpixels and the second subpixels being changed every horizontal period.

12. The organic light emitting display as claimed in claim 10, the control signal being supplied to the transistors electrically coupled to the third subpixels for each horizontal period after the control signals are supplied to transistors electrically coupled to the first subpixels and the second subpixels.

13. The organic light emitting display as claimed in claim 1,
the first subpixel being a red subpixel,
the second subpixel being a green subpixel, and
the third subpixel being a blue subpixel.

14. The organic light emitting display as claimed in claim 1,
the first subpixel and the second subpixel being arranged to be positioned on an upper side and a lower side in one row line, and
the third subpixel being arranged in a column designated sequentially higher than the designation of the column holding the first subpixel and the second subpixel.
